(19) United States
(12) Patent Application Publication
(10) Pub. No.: US 2026/0081411 A1
(43) Pub. Date: Mar. 19, 2026

(54) Predicting Vibrations of Overhead Transmission Lines

(71) Applicant: Saudi Arabian Oil Company, Dhahran (SA)

(72) Inventors: Abdallah Guraishi, Dhahran (SA); Rafat Rob, Dhahran (SA)

(21) Appl. No.: 18/884,766

(22) Filed: Sep. 13, 2024

(51) Int. Cl. H02G 7/02; G01H 17/00; G01K 1/02; H02G 7/14

(52) U.S. Cl. CPC H02G 7/02; G01H 17/00; G01K 1/026; H02G 7/14

(57) ABSTRACT

A method for predicting vibrational characteristics of an overhead transmission line that includes obtaining temperature training data, vibration training data, and weather training data and determining a predictive model that predicts a vibration in the overhead transmission line based on values of the training data. The predictive model describes a relationship between ambient temperature and vibrational characteristics impacting the overhead transmission line. The method includes processing, by the predictive model, temperature data and weather data to predict vibrational characteristics, and in response to the predicted characteristics, the method includes generating instructions to modify one or more properties of a power delivery system that includes the overhead transmission line.

### TECHNICAL FIELD

The present disclosure relates to predicting vibrations of overhead conductors.

### BACKGROUND

Overhead transmission lines are essential elements of many power delivery systems, facilitating a transmission of electrical energy and/or electrical signals across large distances from power generation facilities to end users. The overhead transmission lines are suspended on towers or poles, traverse diverse and often challenging terrains, making them susceptible to a variety of environmental and operational stresses. Reliable operation of these transmission lines is critical, as failures can lead to significant disruptions in power supply, posing risks to public safety and potential economic loss. Maintenance practices involve periodic manual inspections, analysis of data from sensors installed along the overhead transmission lines, and appropriate repairs, in which technicians often rely on visual inspections to identify issues such as corrosion, physical damage, and vegetation encroachment.

### SUMMARY

This disclosure describes techniques that include predicting vibrational characteristics of overhead conductors, e.g., an overhead power line or other overhead transmission lines. The techniques further include controlling the vibrations based on these predictions, such as ensuring the vibrations that occur remain under a threshold vibration. Predicting vibrational characteristics of overhead transmission lines is important for determining transmission lines in need of preventative maintenance, minimizing downtime of associated power delivery systems, fault detection, and general condition monitoring of complex power delivery systems. This disclosure describes a method of training a predictive model on historical temperature and vibration data of overhead transmission lines to predict vibrational characteristics based on ambient temperature measurements.

Implementations of the systems and methods of this disclosure can provide various technical benefits. An adaptive and predictive model for predicting vibrational characteristics of overhead transmission line enables fault detection and damage prevention or mitigation through recognition of vibration anomalies. The predictive model can identify probable defects in power delivery systems. The identification enables timely maintenance and prevents potentially detrimental failures. In addition, the predictive model enables continuous monitoring (or nearly continuous monitoring) of power delivery systems and of health profiles of power delivery system components, like gears and bearings, through the monitoring of vibration patterns. Furthermore, the predictive model enables maintenance personnel to identify opportunities for predictive maintenance by predicting vibration-related problems in advance to minimize downtime and maintenance costs. Additionally, power delivery system operators can preemptively modify one or more components to control vibrational characteristics of overhead transmission line spans through a use of tension adjustments, dampers, vibration absorbers, and/or vegetation management techniques.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a power delivery system that includes overhead transmission lines.

FIG. 2 illustrates an example approach for predicting vibrational characteristics of an overhead transmission line.

FIG. 3 illustrates an example approach for determining a predictive model for predicting vibrational characteristics of an overhead transmission line and updating the predictive model based on vibration and temperature measurements.

FIG. 4 is a flow diagram of an example process for training a predictive model to predict vibrational characteristics of an overhead transmission line.

FIG. 5 is a flow diagram of an example process for implementing an optimization procedure for determining variables representative of a physics-based model of an overhead transmission line.

FIG. 6 is a flow diagram of an example process for predicting vibrational characteristics of an overhead transmission line.

FIG. 7 is a diagram of an example computing system.

Like reference numbers and designations in the various drawings indicate like elements.

### DETAILED DESCRIPTION

This disclosure describes techniques that can be used for predicting vibrational characteristics of an overhead transmission line. Rather than requiring monitoring of vibrational characteristics of a transmission line, the systems and processes described in this disclosure can generate predictions of vibrational conditions of a power line based on data that can be measured and processed in real-time or near real-time. These data can include values for load on a power line, e.g., a presence of ice on the transmission line, wind speed near the power line, and ambient temperature near the power line. Based on these measurements and prediction models described below, the systems and methods can determine if mitigation steps should be implemented in real-time or near real-time because of the use of the data describing current (real-time) vibrational characteristics.

Specifically, the systems and models described herein are for predicting vibrations of an overhead transmission line in response to changes in ambient temperature. A trained predictive model receives historical data and real-time field data and predicts vibrational characteristics of spans of overhead transmission lines. The predictions generated by the trained predictive model enable the system to anticipate future detrimental vibrational conditions based on temperature and cause implementation of preventative measures to mitigate vibration-related hazards.

As the system acquires new real-time data, the system updates the predictive model based on observed vibration characteristics. The updated model outputs instructions to control use of the overhead transmission line to adapt to the changing vibrational response in the overhead transmission line from temperature changes over time.

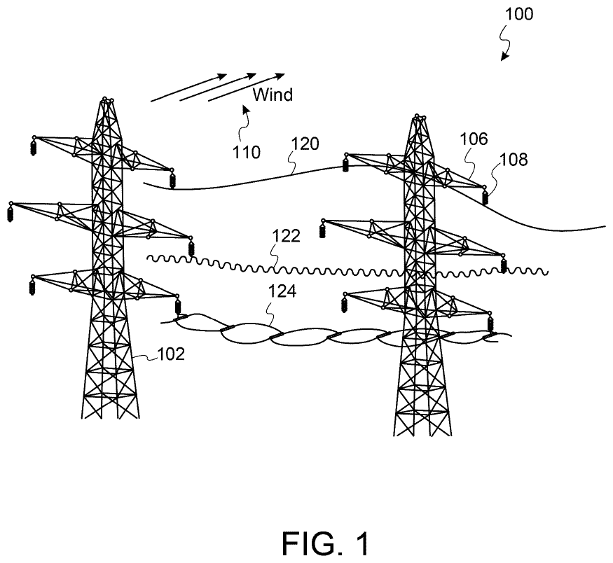

FIG. 1 is a schematic view of a power delivery system 100 that includes a span of an overhead transmission line. The power delivery system 100 includes multiple components that contribute to the transport and delivery of electricity from electricity generation sources, e.g., power plants, to end users. Components of the power delivery system 100 include transmission towers 102, conductors 120-124, e.g., high-temperature low-sag (HTLS) conductors, crossarms 106, insulators 108, and other components not illustrated in FIG. 1, including vibration dampers, spacers, sag and tension control devices, terminal and joint boxes, transformers, and ground wires.

The conductors 120-124 experience vibrations due to multiple environmental factors. These factors can include load forces, such as from ice, temperature, wind, changes in ambient pressure, and so forth. The vibrational response depends on the particular environmental factors and the physical and compositional nature of the overhead transmission line, e.g., the geometry and material of the conductors. Different vibrational mode types are possible, including a Galloping conductor 120 that experiences low frequency and high amplitude vibrations, an Acolian vibration conductor 122 that experiences high frequency and low amplitude vibrations, and a Subspan oscillation conductor 126 that experiences horizontal resonant vibrations. In some cases, the vibrations are in response to changing wind 110 conditions. In some other cases, the vibrations are primarily due to other factors like load and/or temperature changes.

The methods described in this disclosure relate to predicting high frequency and low amplitude vibrations, as demonstrated in FIG. 1 by the Acolian vibration conductor 122. Low amplitude and high frequency vibration can lead to fatigue failure, which can result in accidents and damages related to the power delivery system. To model the Acolian vibration of conductor 122 in response to temperature changes, a free vibration equation of motion of a pre-tensioned Euler Bernoulli beam, as described in relation to the figures below, serves as a foundation.

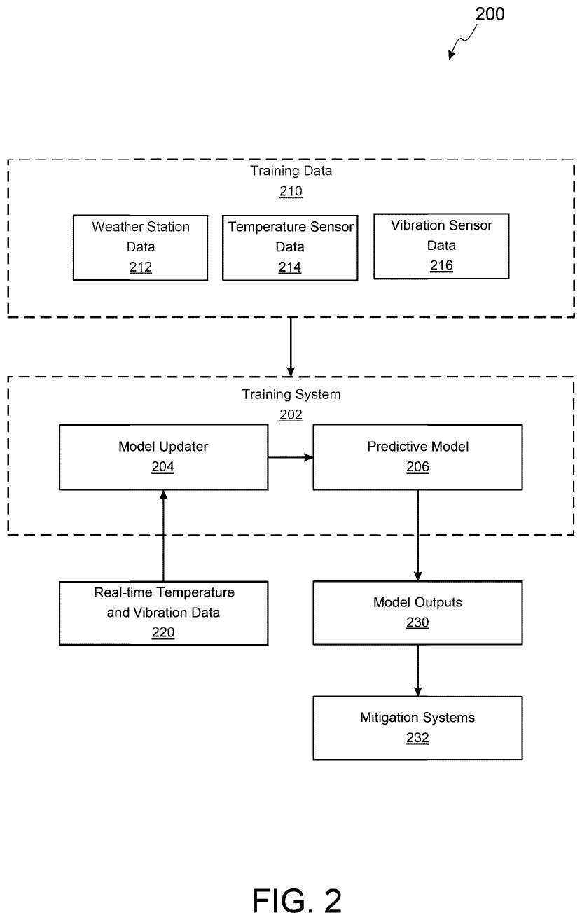

FIG. 2 illustrates an example system 200 for predicting vibrational characteristics of an overhead transmission line. The system 200 includes a training system 202 that trains a predictive model 206 using training data 210 from multiple data sources. The data sources include weather station data 212, temperature sensor data 214, and vibration sensor data 216. As real-time temperature data 220 becomes available, a model updater 204 updates the predictive model 206 to improve the predictive capabilities of the model. In this disclosure, “real-time data” refers to data that is not included in historical databases and is used to make predictions based on current conditions of the overhead transmission line. The predictive model 206 generates one or more model outputs 230. In response to the one or more model outputs 230, one or more mitigation systems 232 process the model outputs 230 that represent vibrational characteristics of the overhead transmission line.

In some implementations, the predictive model 206 includes one or more optimization algorithms. For example, optimization algorithms include simulated annealing and regression models. In some cases, the training system 202 uses one or more fields of the training data 210 determine unknown variables of a physics-based model and/or to determine variables of a linear or non-linear regression function. Further details of particular implementations of the predictive model 206 are provided in the description below.

In some implementations, the training data 210 include data the represent temperature, vibration, and other environmental parameters that affect vibrational modes of the overhead transmission line. The system receives weather station data 212 from one or more weather stations. In some cases, at least one weather station is located in a region that includes the overhead transmission line.

In some implementations, the weather station data 212 include ambient temperature data related to the region that includes the overhead transmission line. The data 212 facilitates precise calculations through meteorological modeling of conductor temperature, in which meteorological phenomena including solar radiation and wind convection are considered. The system 202 can model the thermal behavior of the overhead transmission line, e.g., the heat dissipation, with a thorough understanding of the overhead transmission line thermal properties that are affected by ambient temperature fluctuations. In addition to ambient temperature, in some cases, the weather station data 212 can include meteorological data like wind data, pressure data, and other data that describe conditions around the overhead transmission line.

The system 200 receives temperature sensor data 214 from one or more temperature sensors. In some implementations, each temperature sensor is positioned at a different location along the length of the overhead transmission line. In some implementation, one or more temperature sensors are fixed to a respective component of the power deliver system and measures the ambient temperature of a respective region around the overhead transmission line. In some other implementations, one or more temperature sensors directly measure a temperature of a respective portion of the conductor of the overhead transmission line through direct coupling or thermal radiative coupling.

The system 200 receives vibration sensor data 216 from one or more vibration sensors. Similar to the temperature sensors, in some implementations, each vibration sensor is positioned at a different location along the length of the overhead transmission line and evaluates one or more vibrational characteristics of the respective portion of the overhead transmission line. Vibrational characteristics include vibration frequency and vibration amplitude.

The weather station data 212, temperature sensor data 214, and/or vibration sensor data 216 can include historical data collected and stored by respective sensors and stored in one or more databases. In some implementations, the historical data include temperature and vibrational characteristics with corresponding timestamps. In some implementations, the training data 210 includes the historical data.

In some implementations, the predictive model 206 is a physics-based model that models physical characteristics of the overhead transmission line. Parameters including temperature, tension, sag, material type, and geometric characteristics of the overhead transmission line are considered and described in detail below. For a physics-based model to perform as the predictive model 206, one or more unknown variables are determined by fitting an analytical model to the training data 210. In some other implementations, alternative model types that consider additional variables may be suitable for modeling a particular overhead transmission line.

In some implementations, the system 202 determines the one or more variables of the predictive model 206 by an optimization technique. For example, simulated annealing is a technique that mimics a cooling process of a solid substance to solve optimization tasks that involve combinations of unknown variables. This technique includes minimizing or maximizing a cost/objective function across a limited set of unknown variables. The technique can determine local minima/maxima of a cost/objective function to determine an optimal set of unknown variables. Other optimization techniques including genetic algorithm and gradient descent may be suitable as well. As the system 200 obtains new data, the optimization process can be repeated to determine new variables of the physics-based model.

In some cases, power system operators implement one or more mitigation systems 232 to minimize detrimental effects of vibrations predicted to cause damage to the system. For example, system operators can adjust line tension on one or more spans of the power delivery system to modify vibrations of the overhead conductors. As another example, system operators can install and/or adjust vibration dampers and/or absorbers to modify vibrations of the overhead transmission lines. As another example, system operators and other personnel can modify nearby vegetation to influence environmental attributes of the overhead transmission lines.

In some implementations, the mitigation system 232 include alarms that are indicative of required mitigation steps. In some implementations, the alarms of the mitigation system 232 are communicated through a graphical user interface. In some implementations, the mitigation systems 232 include automated mitigation steps, in which components and/or systems of a corresponding power delivery system are adjusted in response to the alarms.

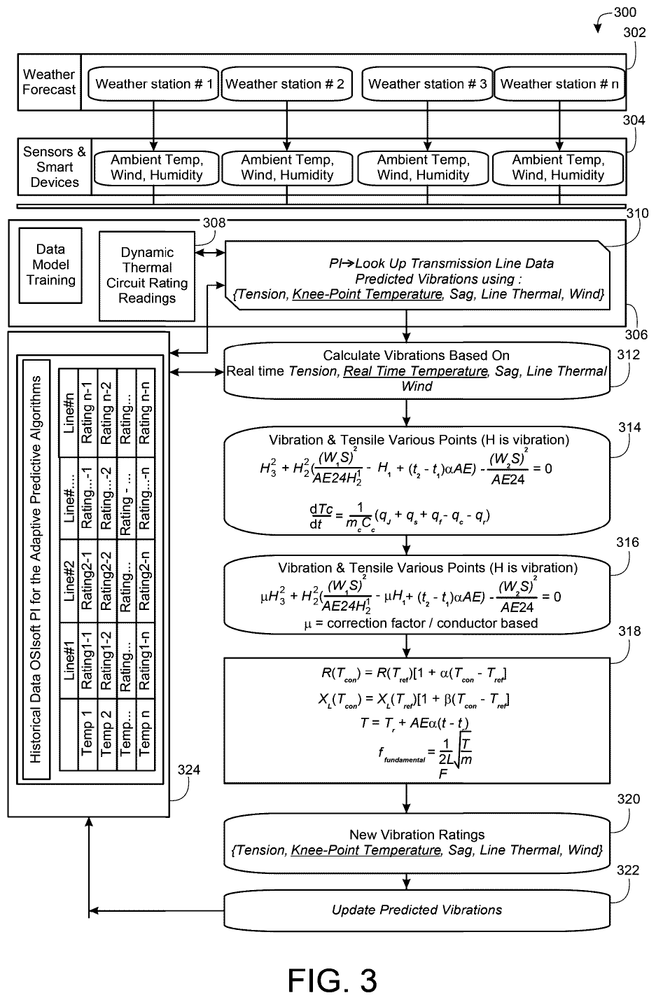

FIG. 3 illustrates an example approach 300 for determining a predictive model for predicting vibrational characteristics of an overhead transmission line and updating the predictive model based on measurements of environmental parameters. For clarity of presentation, the description that follows generally describes approach 300 in the context of the other figures in this description. One or more actions of the example approach 300 can be performed by the system 200, also referred to as the system in the description below.

In some implementations, the predictive model processes data from one or more data sources. The example approach 300 includes weather forecast data 302 and sensor/smart device data 304. In some implementations, the weather forecast data 302 originates from multiple weather stations, in which the weather stations predict meteorological variables for particular regions and particular time frames. In some implementations, the sensor/smart device data 304 originates from one or more sensors along the overhead transmission line, in which a particular sensor evaluates a parameter (e.g., ambient temperature, wind velocity, humidity, etc.) for a particular span or position along the length of the overhead transmission line.

In some implementations, the weather forecast data 302 and sensor/smart device data 304 are stored in a common data repository. In some cases, the data 302 and data 304 are stored in a repository and provide historical data to be used to train a predictive model. In other cases, the data 302 and data 304 represent real time data and are processed by the trained predictive model to provide prediction of future vibrational characteristics based on the real time data.

In some implementations, a data model training system 306 processes the weather forecast data 302 and the sensor/smart device data 304 to train one or more predictive models. The data 302 and data 304 provide variables to evaluate a Dynamic Thermal Circuit Rating (DTCR 308) of the overhead transmission line. The DTCR 308 reading represents a maximum capability of a transmission line to transmit power, and considers variables such as meteorological conditions, temperature, wind, and electrical demand. The DTCR 308 represents dynamic variables to mitigate risk of overload under unfavorable conditions and allows operators to monitor electrical loads of overhead transmission lines to enhance dependability and safety of power delivery systems. In some cases, DTCR 308 systems include data from sensors (e.g., temperature, pressure, and humidity sensors), weather data, and computational algorithms to provide ongoing monitoring and adaptive adjustment of overhead transmission line conductor ratings. The combination of multiple data sources and data processing approaches facilitates infrastructure optimization, utilization, and mitigates potential risks of overheating failures due to harsh weather conditions, e.g., high winds and/or extreme temperatures.

The data model training system 306 evaluates the DTCR 308 and historical transmission line data 310, e.g., tension, knee-point temperature, sag, line thermal, wind, etc., to process with a physics-based model to calculate vibrations. Based on the analytical expressions as described below and an expression for a vibration analysis for various points 314-318 of a transmission line, the system determines a new vibration rating 320. The new vibration rating 320 includes a predicted fundamental vibration frequency of the overhead transmission line. The system updates (322) a set of one or more stored vibration predictions with the new vibration rating 320 in a table of historical data 324. In some implementations, the system retrains and/or updates a determination of estimated variables of one or more predictive models based on the updated table of historical data 324.

In some cases, the temperature of the overhead transmission line influences vibrational characteristics of the overhead transmission line. The relationship between temperature and vibration depends on multiple parameters including material properties of transmission line conductors and prevailing environmental conditions. For example, prevailing environmental conditions can include wind and ambient temperature.

In general, an overhead transmission line is characterized by a catenary equation. The catenary equation describes a suspended cable or wire subjected to the gravitational force. In the context of overhead transmission lines, the catenary equation is useful to describe the sag, which includes a deviation of the overhead transmission line from the horizontal. The sag affects vibrational parameters of the transmission line. The catenary equation is expressed as

$$y ( x ) = a * cosh ( \frac{x - b}{a} ) ,$$

where y(x) represents a vertical displacement of the cable at a specific horizontal position x. The parameter a is a constant that is determined by the cable's weight per unit length and the tension in the cable. The parameter b is a constant that is determined by the horizontal position of the beginning of the cable.

In addition to the geometric description of the overhead transmission line provided by the catenary equation, the Euler-Bernoulli beam equation provides a mathematical representation of a suspended beam under an applied load and considers parameters like temperature and vibration. The Euler-Bernoulli beam equation facilitates a computation of a deflection of the overhead transmission line as a consequence of temperature fluctuations which influence the vibrational characteristics of the line. The Euler-Bernoulli beam equations is expressed as

$$q = \frac{{d}^{2}}{{dx}^{2}} ( EI \frac{{d}^{2} w}{{dx}^{2}} ) ,$$

where w is an amount of deviation from a normal position, (e.g., under no additional load), temperature, etc., q is a distributed load represented in units of force per unit length, E is an elastic modulus of the conductor of the overhead transmission line, and I is computed with regard to the axis that runs in an opposite direction of the applied load and is interpreted as a moment of inertia of a cross-sectional area of the transmission line conductor. The second derivative of w, the deflection of the overhead transmission line, with respect to the longitudinal position x represents the curvature of the overhead transmission line. In some cases, variations in temperature affect the elastic modulus (E) of the overhead transmission line conductor and/or the distributed load, which relate to a time-dependent curvature of the overhead transmission line, and thus is useful for determining vibrational characteristics, e.g., how the curvature of the overhead transmission line changes over time.

In some cases, the temperature of a conductor, e.g., the conductor of the overhead transmission line, can be determined by an equilibrium between heat produced by a Joule process (e.g., heat produced by the electricity flowing through the conductor) and heat that is lost by convection, radiation, and conduction. Heat lost by convection depends on the ambient environment including wind conditions and by the form of the conductor and surface features. Heat lost by radiation depends on the conductor's emissivity and a temperature gap between the conductor and its surroundings. Heat lost by conduction is typically small for short spans of overhead transmission line, but for long spans, heat lost by conduction can be significant.

By considering the various mechanisms for heat loss and heat generation of the conductor of the overhead transmission line, a correlation between temperature and vibration can be examined. For example, thermal expansion of the conductor causes the clastic modulus to decrease and the length of the conductor to increase, both of which contribute to an increase in the sag, (e.g., increase in curvature), as the temperature rises. A decrease in temperature results in a conductor with less sag with an analogous explanation. Similarly, the internal force per unit area within the conductor that prevents overhead transmission line conductors from deforming as a result of external loads is referred to as the stress of the line. Because the thermal expansion causes the conductor to experience additional strain, the stress levels become increasingly severe as the temperature of the conductor rises.

Transmission of electrical power is subject to effects of dispersed transmission line parameters along the length of the line. The parameters include series resistance, series inductance, shunt conductance, and shunt capacitance. Although many properties depend solely on material properties of the respective conductor and nearby electrical and magnetic fields, temperature impacts the resistivity of the conductor. In some cases, energy management systems operate on pre-established transmission line models that do not account for fluctuation in temperatures on overhead transmission lines. In other words, many energy management protocols assume a particular temperature and are static with respect to temperature moving forward. A representation of a heat balance equation is written as

$$\frac{{dT}_{c}}{dt} = \frac{1}{{m}_{c} {C}_{c}} ( {q}_{J} + {q}_{s} + {q}_{f} - {q}_{C} - {q}_{r} ) ,$$

where T_{c} is the conductor temperature, mc is the mass per unit length of the conductor, Cc is the specific heat capacity of the conductor, q_{J} is the heat produced by Joule heating due to the resistance of the conductor, qₛ is the heat produced by q_{C} is the heat exchanged by convection to the air surrounding the conductor, qᵣ heat exchange due to radiative dissipation, qₛ is heat absorbed through radiation from the sun, and q_{f} is heat added due to friction and/or other mechanical sources of heat.

The tensile strength, e.g., the mechanical tension, of conductors is affected by a range of environmental vectors including air temperature. Temperature sensors are commonly placed along the transmission lines to monitor variables like temperature and humidity. In addition, sensors are commonly placed along the transmission lines to monitor the local tension of the transmission line. An expression for the temperature dependence of the conductor resistance and inductive reactance can be expressed as

$$\begin{matrix}R ( {T}_{c o n} ) = R ( {T}_{r e f} ) [ 1 + α ( {T}_{c o n} - {T}_{r e f} ) ] , \\ {X}_{L} ( {T}_{c o n} ) = {X}_{L} ( {T}_{r e f} ) [ 1 + β ( {T}_{c o n} - {T}_{r e f} ) ] ,\end{matrix}$$

respectively, where T_{con} is the local ambient temperature in a vicinity of the conductor, T_{ref} is a conductor's reference temperature, in which the reference resistance and inductive reactance are known, α is the conductor's temperature coefficient of resistance (expressed in per degree Celsius), and β is the conductor's temperature coefficient of inductive reactance.

Although the above descriptions capture the temperature dependence of the resistance and inductive reactance of a conductor, additional considerations can be made when considering the specific configuration of a conductor as part of an overhead transmission line. For example, the tensile strength of an overhead transmission line conductor depends on other parameters that include the composition of the conductor, the length of the span, the degree of sag, the mass of the conductor, and prevailing meteorological conditions. An expression for the force per unit length of a conductor that results from a given set of conditions above can be written as

$$F = \sqrt{{T}^{2} + {( W l )}^{2}} ,$$

where the force experienced by the conductor due to an accumulation of factors depends on a working tension T, as applied by the power delivery system, the weight of the conductor W, and the length of the span l. An expression for a maximum amount of sag of a conductor can be expressed as

$$D = \frac{W {l}^{2}}{8 T} ,$$

where D represents the maximum amount of sag. An additional useful relationship is a relationship between an initial tensile strength determined at the time of construction and a tensile strength under variable conditions. For example, the variable conditions can include temperatures, weather conditions, etc. The relationship between tensile strength and tensile strength at the time of construction is written as

$$T = {T}_{c} + A E α ( t - {t}_{c} ) ,$$

where A is the cross sectional area of the conductor, E is the yield strength represented as Newtons per square meter, and an expansion factor per degree Celsius is denoted as α. The relationship is proportional to a difference between an ambient temperature t and a reference temperature tᵣ.

A further correlation between the tensile strength at various points along the length of the conductor can be expressed as

$${H}_{3}^{2} + {H}_{2}^{2} ( \frac{{( {W}_{1} S )}^{2}}{24 A E {H}_{2}^{1}} - {H}_{1} + ( {t}_{2} - {t}_{1} ) α A E ) - \frac{{( {W}_{2} S )}^{2}}{24 A E} = 0 ,$$

where H_{{1,2,3}} represent tensile strength at three designated points along the length of the transmission line conductor. W₁ and W₂ represent weights of the conductor per unit length at each point, respectively. S represents the length of the span, A represents the cross sectional area of the conductor, E represents the factor of yield strength, a represents the expansion factor of the conductor, and t_{{1,2}} represent the respective ambient temperatures at each position along the overhead transmission line conductor.

Expanding on the catenary equation above which represents the geometric distribution of the overhead transmission line conductor, additional factors can be included. Considering the particular configuration of an overhead conductor, the catenary equation can be expressed as a function of conductor weight per unit length (w), horizontal tension (H), maximum sag of the conductor (D), and span length(S) as

$$y ( x ) = \frac{H}{w} cosh ( ( \frac{w}{H x} ) - 1 ) = w ( {x}^{2} ) ,$$

in which w(x²) approximates a parabolic function obtained by expanding the catenary equation using a MacLaurin series, e.g.,

$$f ( x ) = f ( 0 ) + {f}^{′} ( 0 ) x + \frac{{f}^{″} ( 0 ) {x}^{2}}{2 !} + … ,$$

which provides an approximate analytical representation of the geometrical distribution of the overhead transmission line conductor.

Additionally, the sag of the overhead transmission line conductor, which is the central point of a particular span that represents the lowest altitude within the span, can be expressed as

$$D = \frac{H}{w} ( cosh ( \frac{w S}{2 H} ) - 1 ) = \frac{w ( {S}^{2} )}{8 H} ,$$

in which a “catenary constant” can be defined as

$$\frac{H}{w} ,$$

and represents a ratio of the height to the weight per unit length, and is subject to fluctuations in temperature, ice and wind loads, and changes in components of the power delivery system over time. As represented in the above equation, the deviation of the conductor from horizontal depends on multiple factors that have dependencies on external parameters including ambient temperature. An oscillating temperature pattern can result in a vibrational pattern represented as an oscillating sag value.

The temperature dependence of the length of the overhead transmission line conductor is represented as L(x), measured along the length of the conductor from the lowest point of the catenary in either direction. The catenary equation above can be solved to determine the conductor length, expressed as

$$L ( x ) = \frac{H}{w} sinh ( \frac{w x}{H} ) = x ( 1 + ( \frac{{x}^{2} {w}^{2}}{6 {H}^{2}} ) ) ,$$

which represents the length of the conductor as a function of horizontal displacement from the low point of the overhead transmission line conductor. The total length of the overhead transmission line conductor can be expressed as,

$$L = ( \frac{2 H}{w} ) sinh ( \frac{S w}{2 H} ) = S ( 1 + \frac{{S}^{2} {w}^{2}}{24 {H}^{2}} ) = S + \frac{8 {D}^{2}}{3 S} ,$$

in which the final representation of the length of the conductor is proportional to the square of the sag, denoted as D.

The slack of the overhead transmission line conductor is a difference between the conductor length (L) and the span length (S), in which the span length is the horizontal distance between the two ends of the catenary distribution of the overhead transmission line. The slack is expressed as

$$L - S = {S}^{3} ( \frac{{w}^{2}}{24 {H}^{2}} ) = {D}^{2} ( \frac{8}{3 S} ) .$$

The looseness of the conductor in a respective span of the overhead transmission line is represented by the slack of the conductor.

A deflection, e.g., an increase in sag, of an overhead transmission line in response to temperature changes, the temperature-dependence variation of conductive material is considered. For example, the Young's modulus, which is a measure of the stiffness of a material, defined as a ratio of tensile stress to tensile strain, decreases as temperature increases. To determine a deflection of the overhead transmission line under a change in temperature, a change in conductor temperature is first determined. The change in temperature can be estimated from weather data, temperature sensors, or other means of measuring temperature, and denoted as ΔT. In addition to the change in temperature, the Young's modulus of the respective conductor at various temperatures is determined. For example, the Young's modulus of aluminum at a starting temperature is represented as Eᵢₙᵢₜᵢₐₗ and the final temperature as E_{final}. In many cases, the temperature dependence of Young's modulus for a particular material is provided by a material manufacturer. The change in Young's modulus as a function of temperature is expressed as ΔE=E_{final}−Eᵢₙᵢₜᵢₐₗ. In addition to the change in temperature and the change in Young's modulus in response to temperature change, the moment of inertia of the conductor depends on the geometry of the conductor. The deflection angle, which depends on the temperature-dependent Young's modulus and moment of inertia is expressed as

$$M ( x , t ) = ( E * I * \frac{{\partial }^{2} w}{\partial {x}^{2}} ) ,$$

which can be solved for the deflection of the overhead transmission line w(x, t) numerically or analytically.

The vibrational characteristics of an overhead transmission line under tension can be understood through an oscillation model, in which a vibration frequency is interpreted as a natural frequency of a tensioned line and expressed as

$${f}_{f u n damental} = \frac{1}{2 L} \sqrt{\frac{T}{m}} ,$$

where f_{fundamental} is a fundamental frequency of the overhead transmission line, L is the span length of the overhead transmission line, T is the tension of the overhead transmission line expressed in Newtons, and m is the mass per unit length of the respective conductor. To determine a displacement of the overhead transmission line as a function of environmental variables, e.g., temperature, a vibrational amplitude is determined and expressed as

$${A}_{vibration} = \frac{F}{K} ,$$

where A_{vibration} is the vibration amplitude of the overhead transmission line, F is an external excitation force, e.g., a wind load, and K is a stiffness of the line due to tension expressed in units of Newtons per meter.

An understanding of the temperature dependence of the fundamental frequency and vibration amplitude of the overhead transmission line allows a predictive model to be determined.

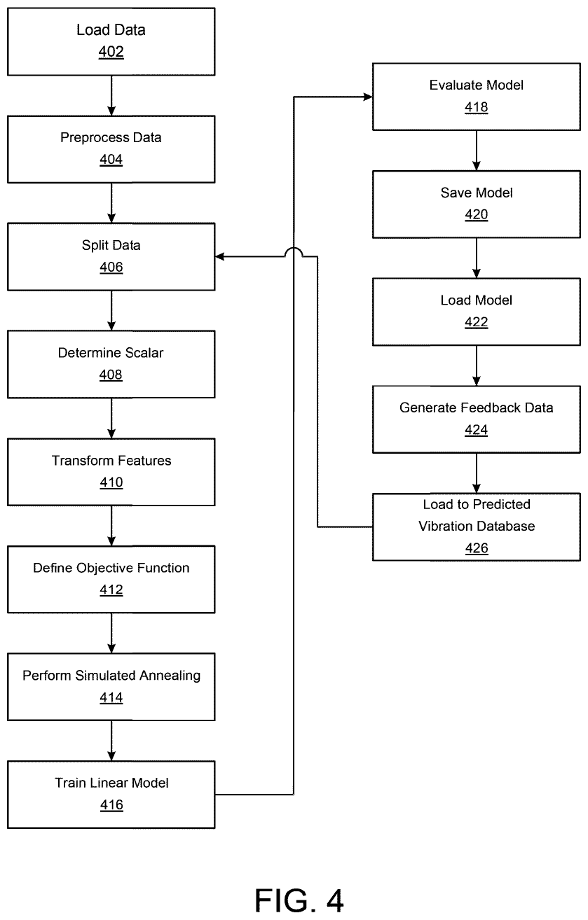

FIG. 4 is a flow diagram of an example process 400 for training a predictive model to predict vibrational characteristics of an overhead transmission line. For clarity of presentation, the description that follows generally describes process 400 in the context of the other figures in this description. In some implementations, various steps of process 400 can be performed in parallel, in combination, in loops, or in any order. One or more steps of process 400 can be performed by the training system 202, also referred to as the system in the description below.

In some implementations, the system trains a regression model to determine a relationship, e.g., a linear relationship, between ambient temperature in a region that includes an overhead transmission line and vibrational characteristics, e.g., vibrational frequency, of the overhead transmission line. In some cases, the vibrational characteristics of the overhead transmission line depend on many variables, including wind, load, geometry, etc. To isolate the effects of ambient temperature on the vibrational characteristics, the system can determine a physics-based model that captures the relationship between multiple variables of a power delivery system that includes the overhead transmission line. With a physics-based model, the specific dependence on ambient temperature can be explored with regression analysis between ambient temperature and vibrational frequency.

The process 400 for training the predictive model begins with the system loading (402) relevant data for determining unknown variables of the physics-based model and for determining a relationship between ambient temperature and vibration attributes. For example, the process 400 includes determining unknown coefficients of a corresponding physics-based model and unknown coefficients of a regression model. For example, input data can include conductor temperature, ambient temperature, solar irradiation and irradiation intensity, wind speed and direction, tension data from line tension monitors, capacity transmission line ampacity, characteristics of conductor material per overhead transmission line section, distributed temperature measurements along each span of the overhead transmission line, sag data from sagometers, surface acoustic wave data, and calibration data from DTCR sensors.

The system preprocesses (404) the loaded data. In some implementations, the system handles missing values, converts categorical variables to standardized forms and/or continuous variables, and other data cleaning and data manipulation processes.

The system splits (406) the loaded data into one or more sub-datasets. In some implementations, the system uses a first dataset (e.g., a training dataset) to determine unknown parameters of the physics-based model and/or regression model, e.g., to train the predictive model. In some implementations, the system uses a second dataset (e.g., a test dataset) to evaluate one or more performance metrics of a trained models. In some implementations, the first dataset and the second dataset each include a non-overlapping subset of the loaded data. In some other implementations, the first dataset and the second dataset each include an overlapping subset of the loaded data.

The system performs one or more standardization processes. For example, the system determines (408) a scalar that reflects a mean and standard deviation for the system to transform (410) the features by removing the mean and scaling each of the features to unit variance. The determining (408) and transforming (410) result in a centering and scaling of the features of the dataset such that effects of outliers in the dataset are reduced.

The system defines (412) an objective function, in which an evaluation of the objective function represents a difference between an output of a predictive model and ground truth data. For example, the ground truth data is data known to accurately reflect measured data. In some implementations, the objective function represents a mean square error between predicted and observed values. In some implementations, the objective function includes an analytical representation of the physics-based model, as described in relation to the description of FIG. 3. In other words, the vibrational response of an overhead transmission line to external parameters, e.g., temperature, is captured through analytical descriptions represented in the defined objective function.

In some implementations, the objective function quantifies undesired effects of overhead transmission line vibrations. The objective function can include a combination of functions, including vibrational energy (Eᵥ(x)), maximum vibration amplitude (Aₘₐₓᵢₘᵤₘ(x)), and stress/strain energy (S(x)). The vibrational energy represents a total vibration energy of the overhead transmission line, including contributions from multiple vibrational modes. The maximum amplitude represents a peak amplitude of oscillations experienced by the overhead transmission line. The stress/strain energy represents internal stresses/strains in the overhead transmission line due to vibration. In some cases, the objective function is expressed as ƒ(x)=αEᵥ(x)+βAₘₐₓᵢₘᵤₘ (x)+γS(x), in which {α, β, γ} are weighting parameters that represent a priority of each vibrational function described above.

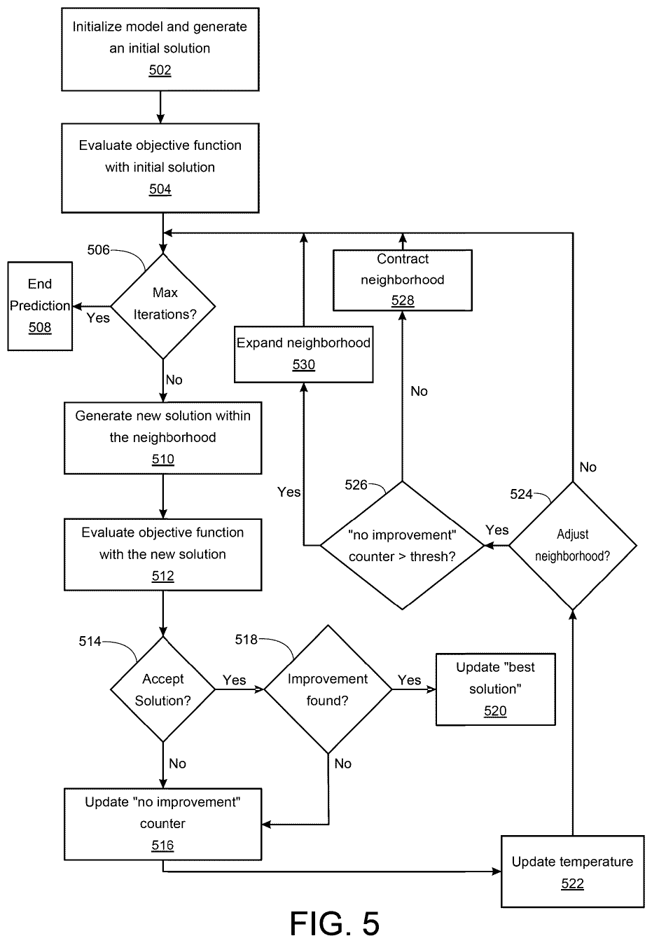

The system performs (414) a simulated annealing process, described in more detail in relation to FIG. 5. The simulated annealing process, or any other optimization process, can determine an estimate of unknown variables of the physics-based model when an analytical solution is difficult to determine. The system initializes parameters processed during the simulated annealing process with the transformed features of step (410). The system evaluates an objective function as described in relation to step (412).

The simulated annealing process includes a calculation of all potential configurations and environmental parameters that impact an overhead transmission line vibration in a state space. The state space χ is a set of parameters that include line tension (T_{L}), which affects inherent frequencies and resistance to vibrations caused by wind. As another example, the set of parameters can include parameters of the overhead transmission line geometry (G_{L}) including line curvature, which impacts aerodynamic characteristics and vibrational responses of the line. As another example, the set of parameters can include material properties (M_{L}) of the overhead transmission line including linear modulus, damping coefficients, and material density. As a further example, the set of coefficients can include environmental parameters including wind speed (ω), wind direction (θ_{ω}), temperature (Tₑₙᵥ), and loading condition (Lₑₙᵥ). The state space (χ) can be expressed as a collection of parameters χ={θ_{ω}, _{ω}, Tₑₙᵥ, Lₑₙᵥ, M_{L}, G_{L}, T_{L}}.

The simulated annealing process includes iteratively calculating a range of state space vectors (χ) and an associated objective function value. The system determines an optimal state space vector (χ*) that corresponds to a minimum objective function value.

The system trains (416) a linear model to predict vibrational characteristics (e.g., vibration frequency) based on a temperature input and based on an output of the simulated annealing process described in relation to the performing (414) step. In some implementations, the output of the simulated annealing process is one or more unknown variables associated with the physics-based model. For example, the system trains (416) a linear model by establishing a linear relationship between ambient temperature and a vibrational characteristic by comparing a difference between observed vibrational characteristics in the first dataset (e.g., the training dataset) and the predicted values determined by the linear model based on the outputs of the analytical model determined by the simulated annealing process. In some implementations, the system trains a non-linear model to predict the vibrational characteristics based on temperature input.

The system evaluates (418) the trained linear model. For example, the trained linear model is a linear model with an estimated linear coefficient and an estimated offset. In some implementations, the system evaluates the trained linear model with a mean square error function by calculating the mean square error between the predicted values from the trained linear model and the second dataset (e.g., the test dataset).

In some implementations, the system saves (420) the trained linear model, loads (422) the trained linear model, generates (424) feedback data related to the accuracy of the trained linear model, and loads (426) the predicted vibrational characteristics to one or more databases. In some implementations, the databases store data including predicted vibrational characteristics, previously measured vibrational characteristics, feedback adjustment, and system operator action logs. In some implementations, the process is repeated and the updated data that includes the newly predicted vibrational characteristics are included in the dataset that the system loads (402). With new data that is confirmed to be within a degree of accuracy in the loaded dataset, e.g., through the generate (424) feedback step, the system can determine an updated output of the simulated annealing process and determine an updated linear representation of the temperature-vibration relationship.

In some implementations, the feedback data includes a comparison of predicted vibrational characteristics and measured vibrational characteristics corresponding to a common timeframe. In some implementations, the generating (424) of the feedback data is automated. In some implementations, the generating (424) and analysis of the feedback data includes a manual evaluation and/or emergency procedures.

FIG. 5 is a flow diagram of an example process 500 for implementing an optimization process for determining variables representative of a physics-based model of an overhead transmission line. For clarity of presentation, the description that follows generally describes process 500 in the context of the other figures in this description. In some implementations, various steps of process 500 can be performed in parallel, in combination, in loops, or in any order. One or more steps of process 500 can be performed by the training system 202, also referred to as the system in the description below.

The process 500 refers to step 414 as described in relation to FIG. 4. Step 414 of FIG. 4 includes performing (414) a simulated annealing process that determines one or more unknown variables of a physics-based model. The system initializes (502) the model and generates an initial solution of the model. In some implementations, the system initializes parameters of the model with random numbers, random numbers within a pre-defined range, or with values from a previous training step in relation to the process 500. An initial solution is an evaluation of the physics-based model based on the initialized parameters.

In some implementations, the initialized parameters that define a solution to the physics-based model of a particular overhead transmission line include corresponding values of sag, horizontal tension, elevation difference between two towers on either end of a span, span length, cable weight per unit length, distance between left support and a low point of a span, distance between right support and the low point of the span, conductor length, a sag compared to the right support, a sag compared to the left support, a tension at the left support, a tension at the right support, and an average tension across the length of the span.

In some implementations, the simulated annealing process includes modeling a heating and subsequent cooling process of a material. A control parameter of the simulated annealing process is a simulation temperature, which refers to a simulated temperature of the simulated material undergoing an annealing process.

In some implementations, the system determines a first neighborhood of parameter values to explore for an optimal solution. For example, the optimal solution is a solution that corresponds to a minimum value of the objective function. The system determines an initial size of the first neighborhood of parameter values. A neighborhood refers to a set of potential solutions to the physics-based model that can be reached from a current solution by making small modifications of one or more of the parameters. Essentially, it is a collection of nearby solutions that are considered for evaluation and comparison during an optimization process, and the size of the collection is determined by the size of the neighborhood.

Based on the initial solution of the model, the system evaluates (504) the objective function. The value of the objective function is indicative of a difference between the initial solution and values of the training data that represent known values. In some implementations, the objective function is a mean square error between the output of the physics-based model and the training data values.

The system determines (506) if a pre-determined maximum number of iterations has been implemented. In some implementations, an iteration is a single evaluation of the physics-based model, evaluation of the objective function, and a corresponding parameter/neighborhood adjustment. If the system implements the pre-determined number of iterations at any point, the system stops the optimization process and outputs the determined unknown values to a subsequent process step similar to step (416) of process 400. If the system has not yet implemented the pre-determined number of iterations, the system generates (510) a new solution within the first neighborhood of parameter values. In other words, the system slightly adjusts each parameter within the first neighborhood, and a new solution is determined accordingly. The system evaluates (512) the objective function again based on the new solution.

If the system accepts (514) the new solution, the system determines (518) if an improvement is found, e.g., if the output of the objective function based on the new solution is smaller than the output of the objective function based on the initial solution. In some other implementations, the system can maximize the objective function. If the system does not accept (514) the solution, the system updates (516) a “no improvement” counter. Relatedly, if the system determines (518) there to be no improvement, the system updates (516) the “no improvement” counter. If the system determines (518) there to be an improvement between the initial solution and the new solution, the system can update (520) a current “best solution”, in which the system considers the “best solution” to be a solution of the analytical physics-based model until it determines a new solution that yields a smaller evaluated objective function.

In the cases of the system updating (516) the “no improvement” counter and updating (520) the “best solution”, the system updates (522) the simulation temperature. If the system determines (524) that the neighborhood size should not be adjusted, the system repeats the previously described process 500 steps 506-524 by determining (506) if the system has implemented the maximum number of iterations.

If the system determines (524) that the neighborhood size should be adjusted to explore a larger or smaller solution space, the system determines (526) if a “no improvement” counter is greater than a pre-determined threshold. If the system determines (526) that the “no improvement” counter has exceeded the pre-defined threshold, the system expands the size of the neighborhood to explore a larger space of solutions in an effort to find a solution that yields a more optimized evaluated objective function. If the system determines (526) that the “no improvement” counter has not exceeded the pre-defined threshold, the system contracts the size of the neighborhood to further explore a more constrained solution space in an effort to find a more optimized objective function nearby. In both cases, e.g., expansion and contraction, the system repeats the previously described process 500 steps 506-530 with the updated neighborhood size until the system implements the pre-defined maximum number of iterations.

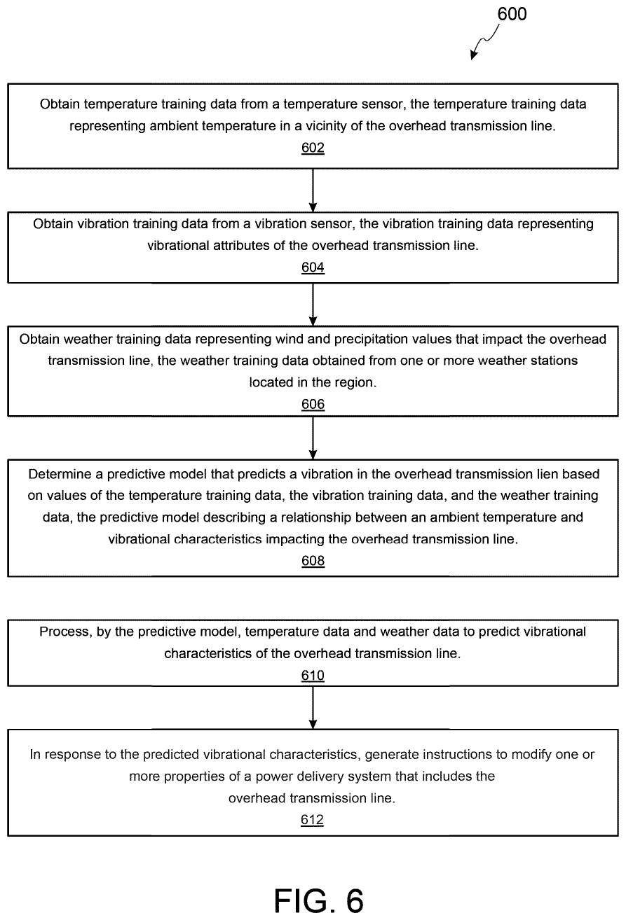

FIG. 6 is a flow diagram of an example process for predicting vibrational characteristics of an overhead transmission line located in a region. For clarity of presentation, the description that follows generally describes process 600 in the context of the other figures in this description. In some implementations, various steps of process 600 can be performed in parallel, in combination, in loops, or in any order. One or more steps of process 600 can be performed by the system 200, also referred to as the system in the description below.

The system obtains (602) temperature training data from a temperature sensor. The temperature training data represents ambient temperature in a vicinity of the overhead transmission line. The system obtains (604) vibration training data from a vibration sensor. The vibration training data represents vibrational characteristics of the overhead transmission line. The system obtains (606) weather training data that represents wind and precipitation values that impact the overhead transmission line. In some cases, the weather training data is obtained from one or more weather stations located in the region. In some cases, the temperature training data, vibration training data, and/or the weather training data are obtained from databases of historical data.

The system determines (608) a predictive model that predicts a vibration in the overhead transmission line based on values of the temperature training data, the vibration training data, and the weather training data. The predictive model describes a relationship between an ambient temperature and vibrational characteristics that impact the overhead transmission line. In some implementations, determining the predictive model includes an optimization process for determining unknown variables of a physics-based, e.g., analytical, model and determining coefficients of a linear relationship, e.g., a linear regression.

The system processes (610), by the predictive model, temperature data and weather data to predict vibrational characteristics of the overhead transmission line. In some cases, the temperature data and weather are not included in respective training data. In some cases, the temperature data and weather data are indicative of real-time, e.g., current, conditions.

In response to the predicted vibration characteristics, the system generates (612) instructions to modify one or more properties of a power delivery system that includes the overhead transmission line. In some cases, the instructions include directives for implementing mitigation actions like installing vibration dampers, adjusting transmission line tension, and/or managing nearby vegetation.

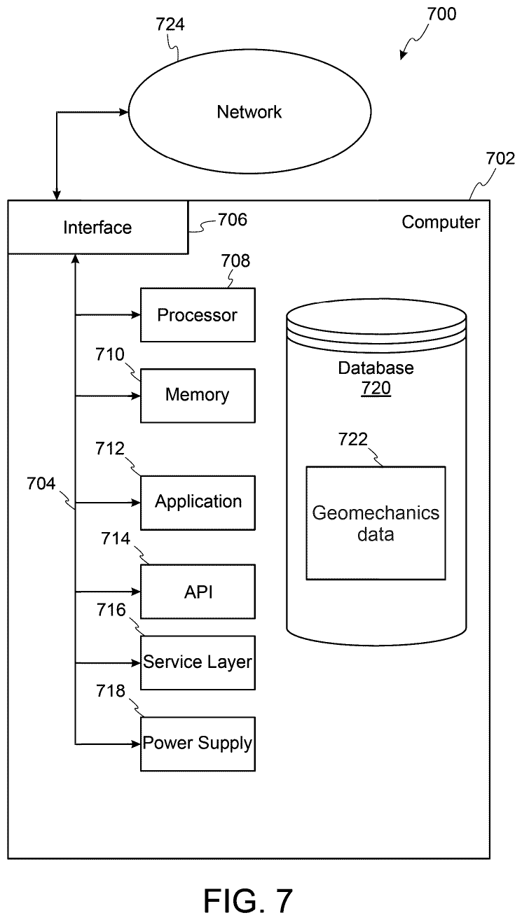

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 724. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 724 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 704. In some implementations, any or all of the components of the computer 702, including hardware or software components, can interface with each other or the interface 706 (or a combination of both), over the system bus 704. Interfaces can use an application programming interface (API) 714, a service layer 716, or a combination of the API 714 and service layer 716. The API 714 can include specifications for routines, data structures, and object classes. The API 714 can be either computer-language independent or dependent. The API 714 can refer to a complete interface, a single function, or a set of APIs.

The service layer 716 can provide software services to the computer 702 and other components (whether illustrated or not) that are communicably coupled to the computer 702. The functionality of the computer 702 can be accessible for all service consumers using this service layer. Software services, such as those provided by the service layer 716, can provide reusable, defined functionalities through a defined interface. For example, the interface can be software written in JAVA, C++, or a language providing data in extensible markup language (XML) format. While illustrated as an integrated component of the computer 702, in alternative implementations, the API 714 or the service layer 716 can be stand-alone components in relation to other components of the computer 702 and other components communicably coupled to the computer 702. Moreover, any or all parts of the API 714 or the service layer 716 can be implemented as child or sub-modules of another software module, enterprise application, or hardware module without departing from the scope of the present disclosure.

The computer 702 includes an interface 706. Although illustrated as a single interface 706 in FIG. 7, two or more interfaces 706 can be used according to implementations of the computer 702 and the described functionality. The interface 706 can be used by the computer 702 for communicating with other systems that are connected to the network 724 (whether illustrated or not) in a distributed environment. Generally, the interface 706 can include, or be implemented using, logic encoded in software or hardware (or a combination of software and hardware) operable to communicate with the network 724. More specifically, the interface 706 can include software supporting one or more communication protocols associated with communications. As such, the network 724 or the interface's hardware can be operable to communicate physical signals within and outside of the illustrated computer 702.

The computer 702 includes a processor 708. Although illustrated as a single processor 708 in FIG. 7, two or more processors 708 can be used according to implementations of the computer 702 and the described functionality. Generally, the processor 708 can execute instructions and can manipulate data to perform the operations of the computer 702, including operations using algorithms, methods, functions, processes, flows, and procedures as described in the present disclosure.

The computer 702 also includes a database 720 that can hold data (such geomechanics data 722) for the computer 702 and other components connected to the network 724 (whether illustrated or not). For example, database 720 can be in-memory or a database storing data consistent with the present disclosure. In some implementations, database 720 can be a combination of two or more different database types (for example, hybrid in-memory and conventional databases) according to implementations of the computer 702 and the described functionality. Although illustrated as a single database 720 in FIG. 7, two or more databases (of the same, different, or combination of types) can be used according to implementations of the computer 702 and the described functionality. While database 720 is illustrated as an internal component of the computer 702, in alternative implementations, database 720 can be external to the computer 702.

The computer 702 also includes a memory 710 that can hold data for the computer 702 or a combination of components connected to the network 724 (whether illustrated or not). Memory 710 can store any data consistent with the present disclosure. In some implementations, memory 710 can be a combination of two or more different types of memory (for example, a combination of semiconductor and magnetic storage) according to implementations of the computer 702 and the described functionality. Although illustrated as a single memory 710 in FIG. 7, two or more memories 710 (of the same, different, or combination of types) can be used according to implementations of the computer 702 and the described functionality. While memory 710 is illustrated as an internal component of the computer 702, in alternative implementations, memory 710 can be external to the computer 702.

The application 712 can be an algorithmic software engine providing functionality according to implementations of the computer 702 and the described functionality. For example, application 712 can serve as one or more components, modules, or applications. Further, although illustrated as a single application 712, the application 712 can be implemented as multiple applications 718 on the computer 702. In addition, although illustrated as internal to the computer 702, in alternative implementations, the application 712 can be external to the computer 702.

The computer 702 can also include a power supply 718. The power supply 718 can include a rechargeable or non-rechargeable battery that can be configured to be either user- or non-user-replaceable. In some implementations, the power supply 718 can include power-conversion and management circuits, including recharging, standby, and power management functionalities. In some implementations, the power-supply 718 can include a power plug to allow the computer 702 to be plugged into a wall socket or a power source to, for example, power the computer 702 or recharge a rechargeable battery.

There can be any number of computers 702 associated with, or external to, a computer system including the computer 702, with each computer 702 communicating over network 724. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Implementations of the subject matter and the functional operations described in this disclosure can be implemented in digital electronic circuitry, in tangibly embodied computer software or firmware, in computer hardware, including the structures disclosed in this disclosure and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this disclosure can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this disclosure contains many specific implementation details, these should not be construed as limitations on the scope of what may be claimed, but rather as descriptions of features that may be specific to implementations. Certain features that are described in this disclosure in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Several embodiments of these systems and methods have been described. Nevertheless, it will be understood that various modifications may be made without departing from the spirit and scope of this disclosure. Accordingly, other embodiments are within the scope of the following claims.

### EXAMPLES

In some implementations, methods for predicting vibrational characteristics of an overhead transmission line located in a region include obtaining temperature training data from a temperature sensor, the temperature training data representing ambient temperature in a vicinity of the overhead transmission line. The methods include obtaining vibration training data from a vibration sensor, the vibration training data representing vibrational characteristics of the overhead transmission line. The methods include obtaining weather training data representing wind and precipitation values impacting the overhead transmission line, the weather training data obtained from one or more weather stations located in the region. The methods include determining a predictive model that predicts a vibration in the overhead transmission line based on values of the temperature training data, the vibration training data, and the weather training data, the predictive model describing a relationship between an ambient temperature and vibrational characteristics impacting the overhead transmission line. The methods include processing, by the predictive model, temperature data and weather data to predict vibrational characteristics of the overhead transmission line. In response to the predicted vibrational characteristics, the methods include generating instructions to modify one or more properties of a power delivery system that includes the overhead transmission line.

In an example implementation combinable with any other implementation, the methods include receiving new training data and determining a new predictive model that predicts the vibration of the overhead transmission line based on values of the new training data, wherein the new predictive model includes one or more parameters different from the predictive model.

In an example implementation combinable with any other implementation, determining the predictive model includes determining coefficients of a physics-based model with an optimization procedure, the physics-based model representing a vibrational response of the overhead transmission line in response to environmental factors, and determining coefficients of a regression model, the regression model representing a relationship between the ambient temperature and vibrational characteristics of the overhead transmission line.

In an example implementation combinable with any other implementation, the methods include displaying the predicted vibrational characteristics and related alarms on a graphical user interface, the graphical user interface displaying instructions for modifying one or more properties of the power delivery system.

In an example implementation combinable with any other implementation, the instructions to modify one or more properties of the power delivery system are relate to actions that include at least one of adjusting the power line tension, installing and/or adjusting vibrational dampers, and managing nearby vegetation to prevent a fault or failure of the overhead power line.

In an example implementation combinable with any other implementation, the vibrational characteristics include a vibrational amplitude and a vibrational frequency of the overhead power line.

In an example implementation combinable with any other implementation, each temperature sensor of the one or more temperature sensors measure a temperature that corresponds to a different position along a length of the overhead power line.

In an example implementation combinable with any other implementation, each vibration sensor of the one or more vibration sensors measure vibrational characteristics that correspond to different positions along a length of the overhead power line.

In an example implementation combinable with any other implementation, the predictive model is configured to discard the weather data for generating a prediction of the vibrational characteristics of the overhead power line, wherein the ambient temperature is evaluated in a region that includes the overhead power line.

What is claimed is:

1. A method for predicting vibrational characteristics of an overhead transmission line located in a region, the method comprising:
obtaining temperature training data from a temperature sensor, the temperature training data representing ambient temperature in a vicinity of the overhead transmission line;
obtaining vibration training data from a vibration sensor, the vibration training data representing vibrational characteristics of the overhead transmission line;
obtaining weather training data representing wind and precipitation values impacting the overhead transmission line, the weather training data obtained from one or more weather stations located in the region;
determining a predictive model that predicts a vibration in the overhead transmission line based on values of the temperature training data, the vibration training data, and the weather training data, the predictive model describing a relationship between an ambient temperature and vibrational characteristics impacting the overhead transmission line;
processing, by the predictive model, temperature data and weather data to predict vibrational characteristics of the overhead transmission line; and
in response to the predicted vibrational characteristics, generating instructions to modify one or more properties of a power delivery system that includes the overhead transmission line.

2. The method of claim 1, further comprising:
receiving new training data;
determining a new predictive model that predicts the vibration of the overhead transmission line based on values of the new training data, wherein the new predictive model includes one or more parameters different from the predictive model.

3. The method of claim 1, wherein determining the predictive model comprises:
determining coefficients of a physics-based model with an optimization procedure, the physics-based model representing a vibrational response of the overhead transmission line in response to environmental factors; and
determining coefficients of a regression model, the regression model representing a relationship between the ambient temperature and vibrational characteristics of the overhead transmission line.

4. The method of claim 1, further comprising displaying the predicted vibrational characteristics and related alarms on a graphical user interface, the graphical user interface displaying instructions for modifying one or more properties of the power delivery system.

5. The method of claim 1, wherein the instructions to modify one or more properties of the power delivery system are relate to actions that include at least one of adjusting the power line tension, installing and/or adjusting vibrational dampers, and managing nearby vegetation to prevent a fault or failure of the overhead power line.

6. The method of claim 1, wherein the vibrational characteristics include a vibrational amplitude and a vibrational frequency of the overhead power line.

7. The method of claim 1, wherein each temperature sensor of the one or more temperature sensors measure a temperature that corresponds to a different position along a length of the overhead power line.

8. The method of claim 1, wherein each vibration sensor of the one or more vibration sensors measure vibrational characteristics that correspond to different positions along a length of the overhead power line.

9. The method of claim 1, wherein the predictive model is configured to discard the weather data for generating a prediction of the vibrational characteristics of the overhead power line, wherein the ambient temperature is evaluated in a region that includes the overhead power line.

10. A system for predicting vibrational characteristics of an overhead transmission line located in a region, the system comprising:
at least one processor;
a memory storing instructions that, when executed by the at least one processor, cause the at least one processor to perform operations comprising:
obtaining temperature training data from a temperature sensor, the temperature training data representing ambient temperature in a vicinity of the overhead transmission line;
obtaining vibration training data from a vibration sensor, the vibration training data representing vibrational characteristics of the overhead transmission line;
obtaining weather training data representing wind and precipitation values impacting the overhead transmission line, the weather training data obtained from one or more weather stations located in the region;
determining a predictive model that predicts a vibration in the overhead transmission line based on values of the temperature training data, the vibration training data, and the weather training data, the predictive model describing a relationship between an ambient temperature and vibrational characteristics impacting the overhead transmission line;
processing, by the predictive model, temperature data and weather data to predict vibrational characteristics of the overhead transmission line; and
in response to the predicted vibrational characteristics, generating instructions to modify one or more properties of a power delivery system that includes the overhead transmission line.

11. The system of claim 10, wherein the operations further comprise:
receiving new training data;
determining a new predictive model that predicts the vibration of the overhead transmission line based on values of the new training data, wherein the new predictive model includes one or more parameters different from the predictive model.

12. The system of claim 10, wherein determining the predictive model comprises:
determining coefficients of a physics-based model with an optimization procedure, the physics-based model representing a vibrational response of the overhead transmission line in response to environmental factors; and
determining coefficients of a regression model, the regression model representing a relationship between the ambient temperature and vibrational characteristics of the overhead transmission line.

13. The system of claim 10, wherein the operations further comprise displaying the predicted vibrational characteristics and related alarms on a graphical user interface, the graphical user interface displaying instructions for modifying one or more properties of the power delivery system.

14. The system of claim 10, wherein the instructions to modify one or more properties of the power delivery system are relate to actions that include at least one of adjusting the power line tension, installing and/or adjusting vibrational dampers, and managing nearby vegetation to prevent a fault or failure of the overhead power line.

15. The system of claim 10, wherein the vibrational characteristics include a vibrational amplitude and a vibrational frequency of the overhead power line.

16. The system of claim 10, wherein each temperature sensor of the one or more temperature sensors measure a temperature that corresponds to a different position along a length of the overhead power line.

17. The system of claim 10, wherein each vibration sensor of the one or more vibration sensors measure vibrational characteristics that correspond to different positions along a length of the overhead power line.

18. The system of claim 10, wherein the predictive model is configured to discard the weather data for generating a prediction of the vibrational characteristics of the overhead power line, wherein the ambient temperature is evaluated in a region that includes the overhead power line.
